(19) United States
(12) Patent Application Publication
(10) Pub. No.: US 2024/0099297 A1
(43) Pub. Date: Mar. 28, 2024

(54) HIGHLY LOADED EMULSIFIABLE CONCENTRATE FORMULATION OF TRICLOPYR AND PICLORAM

(71) Applicant: Adama Australia Pty Limited, St Leonards, NSW (AU)

(72) Inventor: Andrew HORSFIELD, St Leonards (AU)

(73) Assignee: Adama Australia Pty Limited, St Leonards, NSW (AU)

(21) Appl. No.: 18/272,427

(22) PCT Filed: Jan. 14, 2022
(86) PCT No.: PCT/AU2022/050016

§ 371 Date: Jul. 14, 2023

(30) Foreign Application Priority Data
Jan. 15, 2021 (AU) 2021900076

(51) Int. Cl. A01N 25/04; A01N 43/40; A01P 13/00

(52) U.S. Cl. CPC A01N 25/04; A01N 43/40; A01P 13/00

(57) ABSTRACT

The invention provides a highly loaded emulsifiable concentrate (EC) co-formulation containing triclopyr and three or more amine salts of picloram.

Preferably, the formulation contains three amine salts of picloram, namely the hexyloxypropylamine salt, the monoisopropylamine salt and the alkylamine ethoxylate salt.

### TECHNICAL FIELD

The invention relates to novel triclopyr and picloram co-formulations. In particular, the invention is concerned with highly loaded emulsifiable concentrate co-formulations containing triclopyr and three or more salts of picloram and methods of preparing the same.

### BACKGROUND ART

Picloram (4-amino-3,5,6-trichloropyridine-2-carboxylic acid) and triclopyr (2-(3,5,6-trichloropyridin-2-yl)oxyacetic acid)) are pyridine herbicides suitable for the control of weeds. Both have been marketed by several suppliers globally as solo formulations or co-formulations (mixtures). These formulations are used for control of weeds in a range of agricultural, commercial and industrial situations.

High concentration formulations are generally desirable: a highly loaded formulation can deliver the required quantity of active ingredient to a user in a smaller volume and lower weight. For formulators, higher concentration formulations reduce the quantity of formulated product to be produced. There is a saving in packaging, freight costs, storage volume and energy costs and a reduction of waste.

Existing co-formulations are usually emulsifiable concentrate (EC) formulations and typically contain an active ingredient concentration of triclopyr 300 g/L+ picloram 100 g/L. Only higher loaded formulations for the solo components are available, such as triclopyr 750 g/L. EC or picloram 240 g/L soluble liquid (SL).

Generally, the EC is a liquid homogenous formulation commonly applied as an emulsion after dilution in water and is a formulation type used for many agricultural products. ECs are mixtures of an oil-soluble active ingredient and emulsifying agents dissolved in organic solvent. The emulsifying agent enables the emulsifiable concentrate to disperse easily in water, thereby forming a “milky” and homogenous emulsion. Such typical ECs usually require tank agitation to form the emulsion and maintain it during spraying. However, many challenges exist with preparing higher loaded EC formulations, e.g., being able to load one or more active ingredients at the desired higher concentration that provides the described benefits for higher concentration formulations whilst maintaining a stable formulation during use and under long term storage conditions.

EC formulations of picolinic acid herbicides in amide solvents are generally known to have poor solution stability on storage, giving rise to crystal formation in the concentrate and/or crystal formation on dilution of the concentrate to form an emulsion. Poor storage stability and the consequential formation of precipitates can disrupt effective use of the herbicide through clogging of spray equipment and/or dosing of the herbicide at a lower rate than desired. However, solo higher loaded picloram EC formulations, as well as other higher loaded picolinic acid herbicides, have been described including picloram acid at 150 g/L in an EC formulation. To prepare such higher loaded picloram (or other picolinic acid herbicides), various amines and solvents have been used to create stable formulations, whereby the picloram (or other picolinic acid herbicides) in the EC formulation is in an acid form combined with an amide solvent.

However, higher loaded mixtures of triclopyr+picloram are not currently commercially available and there is a need for formulating such mixtures. It would be desirable and beneficial to provide highly loaded EC co-formulations of triclopyr+picloram which have acceptable storage stability for effective use and dosing.

Moreover, triclopyr+picloram EC formulations that are not highly loaded usually rely on the hexyloxypropylamine salt of picloram to ensure a stable formulation. The reactant used to create picloram as an hexyloxypropylamine salt, Tomamine®, is not always readily available in large quantities and is often an expensive raw material. Accordingly, there remains a need to develop a method for formulating higher loaded triclopyr+picloram EC stable mixtures that are commercially viable.

Reference to any prior art in the specification is not an acknowledgment or suggestion that this prior art forms part of the common general knowledge in any jurisdiction or that this prior art could reasonably be understood, regarded as relevant, and/or combined with other pieces of prior art by a skilled person in the art.

### SUMMARY OF THE INVENTION

The invention is directed to a highly loaded emulsifiable concentrate (EC) stable co-formulation containing triclopyr and three or more amine salts of picloram.

Until the present invention, highly loaded EC co-formulations of triclopyr+picloram were not commercially available nor had they been previously contemplated. The term ‘highly loaded’ as used herein in relation to an EC co-formulation of triclopyr+picloram means that the co-formulation contains a total of more than 400 g/L of the stated active ingredients (as acid equivalents).

Accordingly, in one aspect of the invention, there is provided a highly loaded emulsifiable concentrate (EC) co-formulation containing triclopyr and picloram, wherein the picloram is present in the form of at least amine three salts.

Preferably, the triple salt results in the formation of two amine salts and a surfactant-salt. In one example, the at least three amine salts of picloram are hexyloxypropylamine salt, monoisopropylamine salt and alkylamino ethoxylate salt. The invention is not limited to these three amine salts.

Preferably, the co-formulation of the invention contains triclopyr at a loading of more than 300 g/L and/or picloram at a loading of more than 100 g/L.

It has been found that the development of the novel triple picloram salt combination during formulation has the advantage of neutralising the picloram acid and provides stable emulsion properties.

Accordingly, in another aspect of the present invention, there is provided a method of preparing a highly loaded emulsifiable concentrate (EC) co-formulation containing triclopyr and picloram, wherein at least three salts of picloram are formed using three different amines as follows:
mixing triclopyr in a solvent with picloram;
adding a first emulsifier;
adding a second emulsifier;
adding a first amine reactant;
adding a second amine reactant; and
maintaining mixing until the formulation is clear and homogenous.

Preferably, the solvent is 2-(2-ethoxyethoxy)ethanol.

In one example the first emulsifier is Termul® 203 (pre-melted at 60° C.).

In one example, the second emulsifier is a tallow amine ethoxylate. Preferably, the tallow amine ethoxylate is Teric® 17M.

In one example the first amine reactant is Tomamine® PA-10L to create picloram hexyloxypropylamine salt.

In one example, the second amine reactant is monoisopropylamine (MIPA) to create picloram MIPA salt.

Preferably the combined weight of the technical components in the formulation is >75%.

As used herein, except where the context requires otherwise, the term “comprise” and variations of the term, such as “comprising”, “comprises and “comprised”, are not intended to exclude further additives, components, integers or steps.

Further aspects of the present invention and further embodiments of the aspects described in the preceding paragraphs will become apparent from the following description, given by way of embodiments and/or examples.

### DETAILED DESCRIPTION OF PREFERRED EMBODIMENTS

Reference will now be made in detail to certain embodiments of the invention. While the invention will be described in conjunction with the embodiments and/or examples, it will be understood that the intention is not to limit the invention to those embodiments/examples. On the contrary, the invention is intended to cover all alternatives, modifications, and equivalents, which may be included within the scope of the present invention.

One skilled in the art will recognize many methods and materials similar or equivalent to those described herein, which could be used in the practice of the present invention. The present invention is in no way limited to the methods and materials described. It will be understood that the invention disclosed and defined in this specification extends to all alternative combinations of two or more of the features mentioned or evident from the text. All of these different combinations constitute various alternative aspects of the invention.

For the purposes of interpreting this specification, terms used in the singular will also include the plural and vice versa.

### Example 1: Highly Loaded Emulsifiable Concentrate (EC) Formulation of Picloram and Triclopyr (Present as its Butoxyl Ethyl Ester)

The components are as set out in Table 1:

TABLE 1
Components

| Content | | Purpose in | Supplier |
|---|---|---|---|
| g/L | Component | Formulation | |
| 156.58 | Picloram Technical | active | Lier Chemical Co. |
| | 95.8% | ingredient | Ltd |
| 664.27 | Triclopyr BEE | active | AMICO Pesticides |
| | Technical 94.2% | ingredient | Limited |
| 61.27 | Tolamine PA-10L | amination | Air Products and |
| | | reactant | Chemicals, Inc. |
| 10.00 | MIPA 99% | amination | Huntsman |
| | | reactant | Corporation Pty |
| | | | Limited |
| 54.00 | TERIC ® 17M5 | emulsifier | Huntsman |
| | | | Corporation Pty |
| | | | Limited |
| 71.82 | TERMUL ®203 | emulsifier | Huntsman |
| | | | Corporation Pty |
| | | | Limited |
| 203.20 | Ethyl-di- | solvent | Huntsman |
| | Glysolv ™ | | Corporation Pty |
| | | | Limited |

Details of the components are as set out in Table 2:

TABLE 2
Component Details

| Trade Name | IUPAC NAME | CAS # |
|---|---|---|
| Picloram Technical 95% | 4-amino-3,5,6-trichloropyridine-2- | 1918-02-1 |
| | carboxylic acid | |
| Triclopyr butoxyethyl ester | 2-butoxyethyl 2-(3,5,6- | 64470-88-8 |
| (BEE) Technical 94% | trichloropyridin-2-yl)oxyacetate | |
| Tomamine ® PA-10L | Hexyloxypropyl amine | 16728-61-3 |
| MIPA 99% | Propan-2-amine or isopropylamine | 78-96-6 |
| TERIC ® 17M5 | proprietary blend, composition | undisclosed |
| | undisclosed | |
| TERMUL ®203 | proprietary blend, composition | undisclosed |
| | undisclosed | |
| Ethyl-di-Glysolv ™ | 2-(2-Ethoxyethoxy)ethanol | 111-90-0 |

To prepare the formulation, by way of example, the following method and the sequence of operations were followed:
1. The Ethyl-di-Glysolv™ was charged into a suitable vessel equipped with a high shear rotor/stator design mixer (e.g., a Silverson batch mixer/homogeniser).
2. Triclopyr BEE Technical was added.
3. High shear mixing was commenced and Picloram Technical was added.
4. Mixing was maintained and molten TERMUL® 203 was added.
5. Mixing was maintained and TERIC® 17M5 was added.
6. Mixing was maintained and Tomamine® PA-10L was added.
7. Mixing was maintained and MIPA was added.
8. High shear mixing was maintained until the product is clear and homogeneous, ensuring all the Picloram was reacted and solubilised.
9. The product was examined according to the specification and adjustments were made as required.

To prepare molten TERMUL® 203 for the above method, the required amount was heated to 60° C. and maintained in a completely molten state prior to addition at step 4 above.

Triclopyr+picloram EC formulations usually rely on the hexyloxypropylamine salt of picloram to ensure a stable formulation. The reactant used to create picloram as an hexyloxypropylamine salt, Tomamine®, is not always readily available in large quantities and is often an expensive raw material. In Australia, at least, MIPA is more readily available for use in production of other herbicides i.e. 2,4-D amine, glyphosate; and can be used in the same solvent/emulsifier system as the hexyloxypropylamine salt.

The use of only hexyloxypropylamine and MIPA salts at the proposed picloram loading of 150 g/L was insufficient to produce a stable formulation at the higher loading with triclopyr. To create a stable formulation, a third amine salt of picloram was used in the method of the invention.

Surprisingly, use of the tallow amine ethoxylate emulsifier, Teric® 17M5, enabled both the formation of a third amine picloram salt (alkylamine ethoxylate salt) and ensured the formulation readily emulsifies on dilution in water.

Potential solvent systems for use in a triclopyr 450+picloram 150 EC formulation are limited by the physical space available as the combined weight of the technical in the formulation is >75% (w/w). Unlike prior art formulations described, the formulation of the invention does not rely on an amide solvent or picloram in an acid form to achieve higher concentrated EC's.

Surprisingly, at a high active ingredient loading of triclopyr+picloram, the ability to dissolve 150 g ae/L of picloram salts into a stable EC formulation was achieved by both use of a high molecular weight solvent (Ethyl-di-Glysolv) at a concentration of 16.7% and the liquid triclopyr technical acting as a co-solvent.

The resultant highly loaded EC formulation of triclopyr+picloram of this example, identified as DS 11142 EC formulation, was analysed as described further below. The analysis is in Table 3:

TABLE 3
Analysis

| Determination | Method | Specification | Analysis | Result |
|---|---|---|---|---|
| Appearance, | Visual | Clear dark amber | Clear dark amber liquid | PASS |
| Physical State & | | to clear dark | | |
| Colour | | brown liquid | | |
| Odour | Olfactory | Slightly Sweet | Slightly Sweet | PASS |
| pH - 1% v/v | CIPAC MT | 3.00-4.5 | 3.61 | PASS |
| dilution | 75.3 | | | |
| Density @ 20° C. | Density | 1.216-1.226 | 1.222 g/mL @ 20° C. | PASS |
| | Meter | g/mL | | |
| | Anton | | | |
| | Paar DMA | | | |
| | 48 | | | |
| Emulsion | CIPAC MT | Initial | Initial emulsification | PASS |
| Characteristics | 36.3 | emulsification | uniform | |
| CIPAC Std Water | 1.0 mL/ | uniform | 30 min no cream, | |
| D Ambient Temp. | 100 mL | 30 min < 0.1 ml | nil oil | |
| (23° C.) | | cream, no free oil | 2 h no cream, nil oil | |
| | | 2 h < 0.1 ml | 24 h re-emulsification | |
| | | cream, no free oil | complete | |
| | | 24 h re- | 24.5 h no cream, nil oil | |
| | | emulsification | | |
| | | complete | | |
| | | 24.5 h < 0.1 ml | | |
| | | cream, no free oil | | |
| | CIPAC MT | Initial | Initial emulsification | PASS |
| | 36.3 | emulsification | uniform | |
| | 5.0 mL/ | uniform | 30 min no cream, | |
| | 100 mL | 30 min < 2.0 ml | nil oil | |
| | | cream, trace oil | 2 h no cream, | |
| | | 2 h < 2.0 ml cream, | nil oil | |
| | | trace oil | 24 h re-emulsification | |
| | | 24 h re- | complete | |
| | | emulsification | 24.5 h no cream, | |
| | | complete | nil oil | |
| | | 24.5 h < 2.0 ml | | |
| | | cream, trace oil | | |
| Persistent Foam | CIPAC | Max 60 ml foam | Initial 55 ml | PASS |
| CIPAC Std | MT 42.7 | after 1 min | After 10 sec 50 ml | |
| Water C | 13.0 mL/ | | After 1 min 48 ml | |
| | 200 mL | | After 3 min 40 ml | |
| | | | After 12 min 12 ml | |
| Active | QCM- | Picloram | Picloram 145 g/L | PASS |
| Ingredient | 169.01 | 141-159 g/l | Triclopyr 448 g/L | |
| Content | | Triclopyr | | |
| | | 428-472 g/l | | |

N.B. Triclopyr reported is present as its butoxyethyl ester

Packaging Stability

A sample of the product in HDPE was weighed and then maintained at 54° C. for a period of 14 days.

TABLE 4
Analysis of Packaging Stability in HDPE

| Sample | Pre-Storage Weight | Post-Storage Weight | Weight Difference |
|---|---|---|---|
| T01 | 327.14 g | 327.15 g | 0.01 g |
| TAS1 | 333.78 g | 333.63 g | 0.15 g |

The formulation was suitable for packaging in a HDPE container with a screw cap closure.

Analysis Methods

The relevant test parameters for emulsifiable concentrate (EC) formulations may be found in Section 3.2 Table 19 of the Australian Pesticides & Veterinary Medicines Authority (APVMA) Guidelines for the Generation of Storage Stability Data for Agricultural Chemical Products (Version 2, 22 Jul. 2015). An outline summary of each method employed follows:
Appearance, Physical State & Colour

These tests were performed visually and are described in descriptive terms.
Odour

This test was performed organoleptically and involves the use of descriptive terms.
Density Anton Paar DMA 48 Density Meter

The Anton Paar density meter was used to calculate the density of liquids and gases based on an electronic measurement of the frequency of oscillation of a U-tube containing the sample at a specified temperature.
pH Collaborative International Pesticides Analytical Council (CIPAC) MT 75.3

The pH value of a mixture of a sample with water was determined by means of a pH meter and electrode system.
Emulsion Characteristics CIPAC MT 36.3

An emulsion of known concentration in standard water was prepared. The stability of this emulsion was then assessed in terms of amounts of free “oil” or “cream” which separates whilst the emulsion was allowed to stand undisturbed for 24 hrs. The ability of the system to re-emulsify at the end of the 24 hrs period was also determined.
Persistent Foam CIPAC MT 47.2

The sample was diluted in a measuring cylinder of standard dimensions which was inverted 30 times and the amount of foam created and remaining after certain times was measured.
Active Constituent Content—QChem Laboratories Analytical Method QCM-169.01

Triclopyr butoxyethyl ester & Picloram were determined by reversed phase high performance liquid chromatography using UV detection and external standardisation. The method is appropriately validated as per the APVMA Guidelines for the Validation of Analytical Methods for Active Constituents and Agricultural Products (Revision 1, Jul. 1 2014).

Storage Stability Methods

The APVMA Guidelines for the Generation of Storage Stability Data for Agricultural Chemical Products (Version 2, 22 Jul. 2015) gives a comprehensive guide to the conduct of stability testing for agricultural chemical products. The procedures contained therein were followed to prepare ambient temperature, elevated temperature (accelerated stability) and cold temperature storage samples as follows:

Two 250 mL specimens were packaged into HDPE containers with screw cap closure (commercial packaging material). The specimens remained in their containers and were stored in an air-conditioned facility at approximately 21° C. for the period prior to ambient temperature and elevated temperature storage.

On the day of initiation of the accelerated storage trial, each of the specimens in their unopened containers were weighed on a top pan balance (Mettler PJ3600 Delta Range: SNR J29589) to determine a starting weight (for use as a comparison with weights at the conclusion of the storage period).

The specimen designated for elevated temperature storage (Accelerated Stability sample TAS1) was placed into a thermostatically controlled oven (VWR Mini Incubator: SNR 0811V1169), heated to 54±2° C., for a period of 14 days. At the end of this period, the sample was removed from the oven and placed into a desiccation chamber to allow cooling to ambience.

The remaining formulation specimen (Time Zero sample T01) was stored at air-conditioned ambient temperatures (˜21° C.) in a locked cabinet for the duration of the elevated temperature storage period.

A sample of the formulation was prepared for low temperature stability testing by placing 100 mL of the post accelerated storage stability formulation specimen (TAS1) into 100 mL ASTM D96 graduated centrifuge tubes and storing it in a refrigerated cabinet (Esatto Model EBF93W: SNR 5G386) at a temperature of 0±2′ C for a total of 7 days.

The storage stability samples of highly loaded EC formulation of triclopyr+picloram were analysed as described above and the results are as follows:

Analyses obtained for Time Zero sample T01 were as provided in Table 3 above.

TABLE 5
Analysis of Accelerated Stability sample TAS1

| Determination | Method | Specification | Analysis | Result |
|---|---|---|---|---|
| Appearance, | Visual | Clear dark amber | Clear dark amber | PASS |
| Physical State & | | to clear dark | liquid | |
| Colour | | brown liquid | | |
| Odour | Olfactory | Slightly Sweet | Slightly Sweet | PASS |
| pH - 1% v/v | CIPAC MT | 3.00-4.5 | 3.30 | PASS |
| dilution | 75.3 | | | |
| Density @ 20° C. | Density | 1.216-1.226 | 1.222 g/mL @ | PASS |
| | Meter Anton | g/mL | 20° C. | |
| | Paar DMA 48 | | | |
| Emulsion | CIPAC MT | Initial | Initial | PASS |
| Characteristics | 36.3 | emulsification | emulsification | |
| CIPAC Std Water | 1.0 mL/100 | uniform | uniform | |
| D Ambient Temp. | mL | 30 min < 0.1 ml | 30 min no cream, | |
| (23° C.) | | cream, no free oil | nil oil | |
| | | 2 h < 0.1 ml | 2 h no cream, nil oil | |
| | | cream, no free oil | 24h re- | |
| | | 24 h re- | emulsification | |
| | | emulsification | complete | |
| | | complete | 24.5 h no cream, | |
| | | 24.5 h < 0.1 ml | nil oil | |
| | | cream, no free oil | | |
| | CIPAC | Initial | Initial | PASS |
| | MT 36.3 | emulsification | emulsification | |
| | 5.0 mL/100 | uniform | uniform | |
| | mL | 30 min < 2.0 ml | 30 min no cream, | |
| | | cream, trace oil | nil oil | |
| | | 2 h < 2.0 ml cream, | 2 h no cream, nil oil | |
| | | trace oil | 24h re- | |
| | | 24 h re- | emulsification | |
| | | emulsification | complete | |
| | | complete | 24.5 h no cream, | |
| | | 24.5 h < 2.0 ml | nil oil | |
| | | cream, trace oil | | |
| Persistent Foam | CIPAC | Max 60 ml foam | Initial 50 ml | PASS |
| CIPAC Std | MT 42.7 | after 1 min | After 10 sec | |
| Water C | 13.0 mL/200 | | 48 ml | |
| | mL | | After 1 min | |
| | | | 42 ml | |
| | | | After 3 min | |
| | | | 36 ml | |
| | | | After 12 min | |
| | | | 18 ml | |
| Active Ingredient | QCM-169.01 | Picloram | Picloram 153 g/L | PASS |
| Content | | 141-159 g/l | Triclopyr 432 g/L | |
| | | Triclopyr | | |
| | | 428-472 g/l | | |

N.B. Triclopyr reported is present as its butoxyethyl ester

The formulation was determined to be stable to heat for 2 weeks at 54° C. for all parameters according to the standard CIPAC accelerated testing regime and therefore is expected to be shelf stable for at least 2 years.

Cold Temperature Stability of Liquid Formulations CIPAC MT 39.3

The formulation was subjected to cold storage condition at 0±2° C. for 7 days and the volume and nature of any separated material was recorded.

TABLE 6
Analysis of Cold Stability sample TCD1

| Determination | Method | Specification | Analysis | Result |
|---|---|---|---|---|
| Low Temperature | CIPAC MT | <0.05 mL | Nil separated | PASS |
| Stability | 39.3 After | separated | material | |
| | 7 Days | material | | |

The absence of any separation or crystal growth indicates the formulation to be cold storage stable.

Accordingly, a highly loaded stable EC co-formulation was prepared containing triclopyr as the butoxyethyl ester at 450 g ae/L plus picloram at 150 g ae/L. The picloram of the embodiment is in the following salt forms:
Hexyloxypropylamine salt 60%
Monoisopropylamine salt 27%
Alkylamine ethoxylate salt 13%

The EC co-formulation of the embodiment contains less than 20% (w/w) solvent, less than 6% Tomamine® PA-10L and less than 1% MIPA to achieve a stable EC formulation.

The development of DS11142 creates both a stable EC formulation of triclopyr+picloram with >450 g ai/L and a novel formulation and process to achieve this 600 g ai/L concentration.

Prior to this invention, applying triclopyr and picloram together relied on either using the existing co-formulations of triclopyr ester+picloram salt such as hexyloxypropylamine with 0.400 g total ai/L, or tank mixing triclopyr ester and picloram salt i.e. potassium, as solo formulations. DS11142 provides a more efficient way to apply triclopyr and picloram than existing available formulations.

As a comparison between the efficiency of the formulations, to apply triclopyr at 450 g/ha+picloram at 150 g/ha, the following volumes of products would be required:
Existing triclopyr 300+picloram 100 EC formulation=1.5 L/ha
Tank mixing highest loading solo formulations i.e. Triclopyr 755 EC+Picloram 240 SL=1.22 L/ha (596 mL/ha+625 mL/ha)
DS11142=1 L/ha

Testing of DS11142 indicates it is a very stable formulation, with accelerated post-storage performance very similar to pre-testing specifications.

The stability of DS11142 is significantly better than alternative formulation platforms, with no signs of temperature dependent stability issues at any stage during the development work. The resultant EC undergoes some colour change over long term high temperature storage but does not suffer from any separation or precipitation issues at both high and low temperatures.

The pre-storage viscosity profile of the EC indicates some shear-thinning behaviour, particularly at lower temperatures. This behaviour is not evident in the post-storage viscosity profile. The post-storage EC displays a more Newtonian non-shear dependent viscosity profile, which is a favourable characteristic after long storage times. Although the low temperature viscosity of the EC appears high, it has been compared to another commercial EC formulation and found to have a comparable viscosity profile and as such is not deemed to be an issue.

In conclusion, the new formulation DS11142 performs excellently in all requisite tests. The formulation has no inherent stability issues and the solvent/surfactant system is robust in all tested water concentrations.

### Example 2: Field Tests

Field Trials analyses were conducted to evaluate the efficacy of the highly loaded EC formulation of triclopyr+picloram of Example 1, identified as DS 11142 EC formulation.

Field Test 1: Campbell Town, Tasmania

At Campbell Town, Tasmania, a trial was conducted to evaluate DS 11142 bioequivalence with Fightback 400 EC for the control of gorse (Ulex europaeus). Other products were also tested. The product details are in Table 7:

TABLE 7
Products

| | Active ingredient | Concentration of | |
|---|---|---|---|
| Product name | (ai) | active ingredient | Formulation |
| DS 11142 | picloram + | 150 g/L + | Emulsifiable |
| | triclopyr | 450 g/L | concentrate |
| Fightback | picloram + | 100 g/L + | Emulsifiable |
| 400 EC | triclopyr | 300 g/L | concentrate |
| Grazon Extra | aminopyralid + | 8 g/L + | Emulsifiable |
| 408 EC | picloram + | 100 g/L + | concentrate |
| | triclopyr | 300 g/L | |
| Victory 300 SL | clopyralid | 300 g/L | Soluble |
| | | | concentrate |
| DOW T-Max | aminopyralid | 30 g/L | Soluble |
| 030 SL | | | concentrate |
| Wetspray 1000 | alcohol alkoxylate | 1000 g/L | Liquid |
| Pulse penetrant | modified | 1000 g/L | Liquid |
| | polydimethylsiloxane | | |
| BS1000 | alcohol alkoxylate | 1000 g/L | Liquid |

Treatments included:
DS 11142 (150 g/L picloram+450 g/L triclopyr) or Fightback 400 EC (100 g/L picloram+300 g/L triclopyr) applied at either 25+75 g ai/100 L or 50+150 g ai/100 L as dilute foliar sprays to the point of run-off, each in a tank mix with Wetspray 1000 (1000 g/L alcohol alkoxylate) at 100 mL/100 L,
DS 11142 or Fightback applied at 1000+3000 g ai/ha as a boom spray application, each in a tank mix with Pulse penetrant (1000 g/L modified polydimethylsiloxane) at 250 mL/100 L,
Grazon Extra 408 EC (8 g/L aminopyralid+100 g/L picloram+300 g/L triclopyr) applied at either 2+25+75 g ai/100 L or 4+50+150 g ai/100 L as dilute foliar sprays to the point of run-off, each in a tank mix with BS1000 (1000 g/L alcohol alkoxylate) at 100 mL/100 L,
a tank mixture of Fightback at 50+150 g ai/100 L+Wetspray 1000 at 100 mL/100 L and either Victory 300 SL (300 g/L clopyralid) at 60 g ai/100 L or DOW T-Max 030 SL (30 g/L aminopyralid) at 8 g ai/100 L, applied as dilute foliar sprays to the point of run-off, and
an untreated control.

Treatments are set out in Table 8:

TABLE 8
Treatments

| | | Rate | | |
|---|---|---|---|---|
| | | Product | Active ingredient | Application |
| No. | Product | (mL/100 L) | (g ai/100 L) | schedule |
| 1 | DS 11142 | 167 | 25 + 75 | Dilute foliar |
| | Wetspray 1000 | 100 | | spray to the |
| 2 | DS 11142 | 333 | 50 + 150 | point of run- |
| | Wetspray 1000 | 100 | | off in a spray |
| 3 | Fightback 400 EC | 250 | 25 + 75 | volume of |
| | Wetspray 1000 | 100 | | 4,500 L/ha |
| 4 | Fightback 400 EC | 500 | 50 + 150 | |
| | Wetspray 1000 | 100 | | |
| 5 | DS 11142 | 6.67 L/ha | 1000 + 3000 | Boom spray |
| | Pulse penetrant | 250 | g ai/ha | application |
| 6 | Fightback | 10 L/ha | 1000 + 3000 | in a spray |
| | 400 EC Pulse | 250 | g ai/ha | volume |
| | penetrant | | | of 150 L/ha |
| 7 | Grazon Extra | 250 | 2 + 25 + 75 | Dilute foliar |
| | 408 EC BS1000 | 100 | | spray to the |
| | | | | point of run- |
| 8 | Grazon Extra | 500 | 4 + 50 + 150 | off in a spray |
| | 408 EC BS1000 | 100 | | volume of |
| | | | | 4,500 L/ha |
| 9 | Untreated control | Nil | Nil | N/A |

Dilute foliar sprays to the point of run-off were applied in a spray volume equivalent to 4,500 L/ha and boom spray applications in a spray volume of 150 L/ha. Damage to gorse flower petals was assessed at 27 days after application (27DAA). Brownout of gorse was assessed at 63DAA and again at 176DAA.

Percent damage to gorse flower petals is shown in Table 9:

TABLE 9
Damage to gorse flower petals at 27DAA

| | | | Damage to gorse flower |
|---|---|---|---|
| | | | petals (% flower area |
| | | Rate | damaged per bush) |
| No. | Treatment | (g ai/100 L) | 27DAA |
| 1 | DS 11142 | 25 + 75 | 63 a |
| | Wetspray 1000 | 100 mL/100 L | |
| 2 | DS 11142 | 50 + 150 | 63 a |
| | Wetspray 1000 | 100 mL/100 L | |
| 3 | Fightback 400 EC | 25 + 75 | 74 a |
| | Wetspray 1000 | 100 mL/100 L | |
| 4 | Fightback 400 EC | 50 + 150 | 61 a |
| | Wetspray 1000 | 100 mL/100 L | |
| 5 | DS 11142 | 1000 + 3000 g | 79 a |
| | Pulse penetrant | ai/ha | |
| | | 250 mL/100 L | |
| 6 | Fightback 400 EC | 1000 + 3000 g | 60 a |
| | Pulse penetrant | ai/ha | |
| | | 250 mL/100 L | |
| 7 | Grazon Extra 408 EC | 2 + 25 + 75 | 71 a |
| | BS1000 | 100 mL/100 L | |
| 8 | Grazon Extra 408 EC | 4 + 50 + 150 | 76 a |
| | BS1000 | 100 mL/100 L | |
| 9 | Untreated control | Nil | 3 b |

| | |
|---|---|
| P-value | 0.0001 |
| LSD (P ≤ 0.05) | tA |

\hat{ } Applied with Wetspray 1000 at 100 mL/100 L
Means followed by the same letter are not significantly different (P = 0.05, LSD)
DAA = Days after application
tA = Original plot means are presented with analysis of variance and letters of separation from data transformed using y = Arcsine square root percent (x)
NSD = No significant difference due to a P-value > 0.05

Percent gorse brownout is shown in Table 10:

TABLE 10
Gorse brownout at 63DAA and 176DAA

| | | | Gorse brownout (% bush | |
|---|---|---|---|---|
| | | Rate | area affected) | |
| No. | Treatment | (g ai/100 L) | 63DAA | 176DAA |
| 1 | DS 11142 | 25 + 75 | 25 f | 96 ab |
| | Wetspray 1000 | 100 mL/100 L | | |
| 2 | DS 11142 | 50 + 150 | 38 ef | 99 ab |
| | Wetspray 1000 | 100 mL/100 L | | |
| 3 | Fightback 400 EC | 25 + 75 | 45 de | 92 b |
| | Wetspray 1000 | 100 mL/100 L | | |
| 4 | Fightback 400 EC | 50 + 150 | 51 cde | 99 ab |
| | Wetspray 1000 | 100 mL/100 L | | |
| 5 | DS 11142 | 1000 + 3000 g | 80 ab | 99 ab |
| | Pulse penetrant | ai/ha | | |
| | | 250 mL/100 L | | |
| 6 | Fightback 400 EC Pulse | 1000 + 3000 g | 68 bc | 89 b |
| | penetrant | ai/ha | | |
| | | 250 mL/100 L | | |
| 7 | Grazon Extra 408 EC | 2 + 25 + 75 | 58 cd | 96 ab |
| | BS1000 | 100 mL/100 L | | |
| 8 | Grazon Extra 408 EC | 4 + 50 + 150 | 89 a | 100 a |
| | BS1000 | 100 mL/100 L | | |
| 9 | Untreated control | Nil | 0 g | 0 c |

| | | |
|---|---|---|
| P-value | 0.0001 | 0.0001 |
| LSD (P ≤ 0.05) | 16.6 | tA |

\hat{ } Applied with Wetspray 1000 at 100 mL/100 L
Means followed by the same letter are not significantly different (P = 0.05, LSD)
DAA = Days after application
tA = Original plot means are presented with analysis of variance and letters of separation from data transformed using y = Arcsine square root percent (x)
NSD = No significant difference due to a P-value > 0.05

There were no mixing or compatibility issues for any treatment at the time of treatment application.

Damage to flower petals was equivalent for all herbicide treatments and was significant compared to the untreated control.

All herbicide treatments caused significant brownout of gorse compared to the untreated control.

At 63DAA, when applied as a dilute spray to the point of run-off, Fightback+Wetspray 1000 was superior to DS 11142+Wetspray 1000 applied at equivalent application rates. At 176DAA, gorse brownout was equivalent for both products, with brownout seen on 92-99% bush area.

DS 11142+Pulse applied by boom spray significantly increased the speed of gorse brownout compared to both application rates of DS 11142+Wetspray 1000 applied as dilute sprays to the point of run-off.

As boom spray applications, at equivalent application rates, gorse brownout was numerically superior with DS 11142+Pulse compared to Fightback+Pulse.

At 63DAA, brownout of gorse was equivalent for both application rates of DS 11142+Wetspray and the tank mixture of Fightback+Victory+Wetspray 1000, however all were statistically inferior to DS 11142+Pulse, Fightback+Pulse, Grazon Extra at 4+50+150 g ai/100 L+BS1000 and Fightback+DOW T-Max+Wetspray 1000.

At 176DAA, Grazon Extra at 4+50+150 g ai/100 L+BS1000, Fightback+Victory+Wetspray 1000 and Fightback+DOW T-Max+Wetspray 1000 caused 100% brownout of gorse; gorse brownout was statistically equivalent for these treatments and all DS 11142 treatments.

At the final assessment timing, remaining green leaf was old growth and no re-growth was seen for any treatment.

Field Test 2: Gatton, Queensland

At Gatton, Queensland, a field trial was conducted to evaluate the bioequivalence of DS 11142 600 EC to Fightback 400 EC for the control of narrow-leaved red ironbark (Eucalyptus crebra) in a pasture situation.

The product details are in Table 11:

TABLE 11
Products

| | Active | Concentration of | |
|---|---|---|---|
| Product name | ingredient (ai) | active ingredient | Formulation |
| DS 11142 600 EC | triclopyr | 450 g/L | Emulsifiable |
| | picloram | 150 g/L | concentrate |
| Fightback 400 EC | triclopyr | 300 g/L | Emulsifiable |
| | picloram | 100 g/L | concentrate |
| Grazon Extra | aminopyralid | 8 g/L | Emulsifiable |
| 408 EC | triclopyr | 300 g/L | concentrate |
| | picloram | 100 g/L | |
| Victory 300 SL | clopyralid | 300 g/L | Soluble concentrate |
| Dow T-Max 30 SL | aminopyralid | 30 g/L | Soluble concentrate |
| Wetspray 1000 | alcohol | 1000 g/L | Liquid |
| surfactant | alkoxylate | | |
| Pulse penetrant | polyether | 1000 g/L | Liquid |
| | modified | | |
| | polysiloxane | | |

Treatments included:
DS 11142 at 100, 200 g ai/100L, in combination with Wetspray surfactant at 100 ml/100L,
DS 11142 at 4000 g ai/ha, in combination with Pulse penetrant at 250 ml/100L.

These treatments were compared with Fightback at the same rates of active ingredient, Grazon Extra 408 EC at 102 or 204 g ai/100L, Fightback at 100 g ai/100 L+Victory 300 SL at 60 g ai/100 L+Wetspray surfactant, Fightback at 200 g ai/100 L+Dow T-Max 30 SL at 8.1 g ai/100L+Wetspray surfactant and an untreated control. The pasture safety of DS 11142 was also evaluated.

All the treatments were applied on narrow-leaved red ironbark in a pasture situation using a hand lance to point of run-off except DS 11142 and Fightback at 4000 g ai/ha, which were applied by hand-held boom, at a spray volume of 150 L/ha, generating a medium spray quality.

Treatments are set out in Table 12:

TABLE 12
Treatments

| | | Rate | | |
|---|---|---|---|---|
| | | | Active | |
| | | Product | ingredient | Application |
| No. | Product | mL/100 L | (g ai/100 L) | schedule |
| 1 | Untreated control | Nil | Nil | N/A |
| 2 | DS 11142 600 EC* | 167 | 75 + 25 | Single foliar |
| 3 | DS 11142 600 EC * | 333 | 150 + 50 | application |
| 4 | Fightback 400 EC * | 250 | 75 + 25 | sprayed to |
| 5 | Fightback 400 EC * | 500 | 150 + 50 | point of run-off on |
| | | | | narrow-leaved red |
| | | | | ironbark. |
| 6 | DS 11142 600 EC # | 6.67 L/ha | 3000 + 1000 g | Single foliar |
| | | | ai/ha | application |
| 7 | Fightback 400 EC # | 10 L/ha | 3000 + 1000 g | with hand-held |
| | | | ai/ha | boom on narrow- |
| | | | | leaved red |
| | | | | ironbark, |
| | | | | in a spray |
| | | | | volume of |
| | | | | 150 L/ha. |

Treatment 2-5 were sprayed to point of run-off using hand lance, whereas, treatments 6 and 7 were sprayed at 150/L/ha using boom spray.
* Applied with Wetspray surfactant at 100 mL/100 L
# Applied with Pulse penetrant at 250 mL/100 L

Narrow-leaved red ironbark density was assessed prior to treatment application, then at 189 days after application (189DAA). Narrow-leaved red ironbark brownout assessments were conducted at 33DAA, 121DAA and 189DAA.

Narrow-leaved red ironbark assessments are shown in Tables 13 and 14:

TABLE 13
Narrow-leaved red ironbark density

| | | | Narrow-leaved red ironbark | |
|---|---|---|---|---|
| | | Rate | density (number per plot) | |
| No. | Treatment | (g ai/100 L) | 0DAA | 189DAA |
| 1 | Untreated control | Nil | 1.4 | 1.4 ab |
| 2 | DS 11142 600 EC * | 75 + 25 | 1.4 | 1.4 ab |
| 3 | DS 11142 600 EC * | 150 + 50 | 2.0 | 1.2 ab |
| 4 | Fightback 400 EC * | 75 + 25 | 1.8 | 1.4 ab |
| 5 | Fightback 400 EC * | 150 + 50 | 2.8 | 2.0 a |
| 6 | DS 11142 600 EC # | 3000 + 1000 | 1.8 | 0.2 c |
| | | g ai/ha | | |
| 7 | Fightback 400 EC # | 3000 + 1000 | 1.4 | 0.0 c |
| | | g ai/ha | | |

| | | |
|---|---|---|
| P-value | 0.4791 | 0.0001 |
| LSD (P ≤ 0.05) | NSD (tL*) | 0.75 |

Treatment 2-5 were sprayed to point of run-off using hand lance, whereas, treatments 6 and7 were sprayed at 150/L/ha using boom spray.
* Applied with Wetspray surfactant at 100 mL/100 L
# Applied with Pulse penetrant at 250 mL/100 L
Means followed by the same letter are not significantly different (P = 0.05, Duncan's New MRT)
DAA = Days after application
NSD = No significant difference due to a P-value > 0.05
tL* = P-value and LSD from data transformed using y = Log (x + 1)

TABLE 14
Narrow-leaved red ironbark density

| | | | Narrow-leaved red ironbark brownout | | |
|---|---|---|---|---|---|
| | | Rate | (% of brownout) | | |
| No. | Treatment | (g ai/100 L) | 33DAA | 121DAA | 189DAA |
| 1 | Untreated | Nil | 0.0 g | 0.0 b | 0.0 d |
| | control | | | | |
| 2 | DS 11142 | 75 + 25 | 3.0 f | 6.0 b | 0.0 d |
| | 600 EC * | | | | |
| 3 | DS 11142 | 150 + 50 | 33.0 abc | 65.0 a | 19.0 cd |
| | 600 EC * | | | | |
| 4 | Fightback | 75 + 25 | 10.0 bcdef | 36.0 ab | 1.0 cd |
| | 400 EC * | | | | |
| 5 | Fightback | 150 + 50 | 9.8 cdef | 6.0 b | 8.0 cd |
| | 400 EC * | | | | |
| 6 | DS 11142 | 3000 + | 31.0 ab | 62.0 a | 98.0 a |
| | 600 EC # | 1000 g | | | |
| | | ai/ha | | | |
| 7 | Fightback | 3000 + | 42.0 a | 74.0 a | 100.0 a |
| | 400 EC # | 1000 g | | | |
| | | ai/ha | | | |

| | | | |
|---|---|---|---|
| P-value | 0.0001 | 0.0001 | 0.0001 |
| LSD (P ≤ 0.05) | tL | tS | 21.44 |

Treatment 2-5 were sprayed to point of run-off using hand lance, whereas, treatments 6 and 7 were sprayed at 150/L/ha using boom spray.
* Applied with Wetspray surfactant at 100 mL/100 L
# Applied with Pulse penetrant at 250 mL/100 L
Means followed by the same letter are not significantly different (P = 0.05, Duncan's New MRT)
DAA = Days after application
tL = Original plot means are presented with analysis of variance and letters of separation from data transformed using y = Log (x + 1)
tS = Original plot means are presented with analysis of variance and letters of separation from data transformed using y = SQRT (x + 0.5)

Pasture safety was assessed 33DAA, 121DAA and 189DAA. Foliage of pasture was inspected for phytotoxic symptoms including necrosis, chlorosis and plant growth effects.

Pasture safety assessments are shown in Table 15:

TABLE 15
Pasture Safety

| | | | Phytotoxicity | | |
|---|---|---|---|---|---|
| | | Rate | (% area affected) | | |
| No. | Treatment | (g ai/100 L) | 33DAA | 121DAA | 189DAA |
| 1 | Untreated control | Nil | 0.0 | 0.0 | 0.0 |
| 2 | DS 11142 600 EC * | 75 + 25 | 0.0 | 0.0 | 0.0 |
| 3 | DS 11142 600 EC * | 150 + 50 | 0.0 | 0.0 | 0.0 |
| 4 | Fightback 400 EC * | 75 +25 | 0.0 | 0.0 | 0.0 |
| 5 | Fightback 400 EC * | 150 + 50 | 0.0 | 0.0 | 0.0 |
| 6 | DS 11142 600 EC # | 3000 + 1000 | 0.0 | 0.0 | 0.0 |
| | | g ai/ha | | | |
| 7 | Fightback 400 EC # | 3000 + 1000 | 0.0 | 0.0 | 0.0 |
| | | g ai/ha | | | |

| | | | |
|---|---|---|---|
| P-value | 1.0 | 1.0 | 1.0 |
| LSD (P ≤ 0.05) | NSD | NSD | NSD |

Treatment 2-5 were sprayed to point of run-off using hand lance, whereas, treatment 6 and 7 were sprayed at 150/L/ha using boom spray.
* Applied with Wetspray surfactant at 100 mL/100 L
# Applied with Pulse penetrant at 250 mL/100 L
DAA = Days after application
NSD = No significant difference due to a P-value > 0.05

Overall, DS 11142 was equivalent to Fightback at equivalent rate for control of narrow-leaved red ironbark in a pasture situation.

DS 11142 600 EC at 200 g ai/100 L, sprayed to the point of run-off, provided significant brownout of narrow-leaved red ironbark (Eucalyptus crebra) up to 121DAA in a pasture situation.

DS 11142 at 4000 g ai/ha, sprayed in a volume of 150 L/ha provided significant control of narrow-leaved red ironbark in a pasture situation.

DS 11142 was bioequivalent to Fightback for the control of narrow-leaved red ironbark in a pasture situation.

DS 11142 was safe to native pasture, under the conditions prevailing in this trial.

Field Test 3: Jandowae, Queensland

Fightback herbicide has been used from time to time as a fallow herbicide in combination with glyphosate particularly for control of melons and certain other hard-to-kill broadleaf weeds, including cowvine, where restrictions on the use of 2,4-D limit deployment of this active in situations adjacent to extremely sensitive crops such as cotton.

A field trial was conducted at Jandowae, QLD to evaluate DS 11142 in combination with Wipeout 450 (450 g/L glyphosate) and to compare this with registered use rates of Fightback herbicide (300 g/L triclopyr+100 g/L picloram) for the control of cowvine in fallow.

Treatments were applied post sorghum harvest using a hand held boom fitted with 4 Hardi MiniDrift green nozzles, calibrated for an output of 100 L/ha at a ground speed of 5.4 kph and an operating pressure of 250 kPa. Treatments were arranged in a Randomized Complete Block Design with a plot size of 2×10 metres and 6 replicates.

Soil type was a black alluvial vertosol. Ground cover of between 10 and 20% of standing sorghum stubble was present across the site. Weeds present at treatment included cowvine and volunteer sorghum. Cowvine was distributed relatively evenly across the site with a density varying between 2 and 6 plants per square metre.

Weed details at application are summarised in Table 16:

TABLE 16
Weed Details

| Weed | Botanical name | Growth stage | Size |
|---|---|---|---|
| Cowvine | Ipomea | 2-8 leaf | 4-20 cm |
| | lonchophylla | Multi leaf- | 20-120 cm |
| | | regrowth | |
| Volunteer | Sorghum bicolor | 4-6 leaf | 15-25 cm |
| sorghum | | | |

Treatments are summarised in Table 17:

TABLE 17
Treatments

| Trt | | Active | Rate |
|---|---|---|---|
| No. | Treatment | g/ha | (product/ha) |
| 1 | Untreated | — | — |
| 2 | DS 11142 | 80 | 133 mL |
| | Wipeout 450 | 540 | 1200 mL |
| 3 | DS 11142 | 160 | 267 mL |
| | Wipeout 450 | 540 | 1200 mL |
| 4 | Fightback | 80 | 200 mL |
| | Wipeout 450 | 540 | 1200 mL |
| 5 | Fightback | 160 | 400 mL |
| | Wipeout 450 | 540 | 1200 mL |
| 6 | Wipeout 450 | 540 | 1200 mL |

Subjective weed assessments were done at 6 DAA, 13 DAA and 27 DAA using a 0-100 percentage scale where 0=no effect and 100=complete control. Initial burndown assessments for cowvine were confined to plants at the 2-8 leaf stage while final control assessments included all weed growth stages.

Data was analysed at a Randomized Complete Block using ARM 9 statistical software. AOV tables were prepared with treatment values identified by different letters being significant according to the Duncan's New Multiple Range test at the 5% level of probability.

Percental initial weed phytotoxicity assessments are shown in Table 18:

TABLE 18
% Initial Weed Phytotoxicity 6 DAA

| Trt No. | Treatment | Rate (product/ha) | Cowvine | Volunteer sorghum |
|---|---|---|---|---|
| 1 | Untreated | — | 0 | 0 |
| 2 | DS 11142 | 133 mL | 48 a | 75- |
| | Wipeout 450 | 1200 mL | | |
| 3 | DS 11142 | 267 mL | 54 a | 78- |
| | Wipeout 450 | 1200 mL | | |
| 4 | Fightback | 200 mL | 53 a | 74- |
| | Wipeout 450 | 1200 mL | | |
| 5 | Fightback | 400 mL | 57 a | 77- |
| | Wipeout 450 | 1200 mL | | |
| 6 | Wipeout 450 | 1200 mL | 35 b | 80- |

Treatments separated by different letters are significantly different at the 5% level of probability using the Duncans New Multiple Range Test.

Volunteer sorghum control was virtually complete in all treated plots with no evidence of antagonism with tank mixes when compared with Wipeout 450 alone.

Weed Control at 13 DAA are shown in Table 19:

TABLE 19
Weed control 23 DAA

| Trt | | | | Volunteer |
|---|---|---|---|---|
| No. | Treatment | Rate (product/ha) | Cowvine | sorghum |
| 1 | Untreated | — | 0 | 0 |
| 2 | DS 11142 | 133 mL | 74 b | 100- |
| | Wipeout 450 | 1200 mL | | |
| 3 | DS 11142 | 267 mL | 91 a | 100- |
| | Wipeout 450 | 1200 mL | | |
| 4 | Fightback | 200 mL | 78 b | 100- |
| | Wipeout 450 | 1200 mL | | |
| 5 | Fightback | 400 mL | 91 a | 100- |
| | Wipeout 450 | 1200 mL | | |
| 6 | Wipeout 450 | 1200 mL | 49 c | 100- |

Treatments separated by different letters are significantly different at the 5% level of probability using the Duncans New Multiple Range test.

All tank mix treatments provided excellent control of cowvine 27 DAA (Table 24) with a numerical trend for increased control at higher rates of addition of DS 11142 and Fightback respectively. In contrast, Wipeout 450 alone gave only 67% control. The data presented demonstrate a clear confirmation for the benefit of including picloram+triclopyr in tank mixes with glyphosate for the control of cowvine up to the multi-leaf stage.

Moreover, the data shows that DS 11142 provides statistically similar control when combined with Wipeout 450 when compared with the registered standard of Fightback

Weed Control at 27 DAA are shown in Table 20:

TABLE 20
Weed control 27 DAA

| Trt | | | | Volunteer |
|---|---|---|---|---|
| No. | Treatment | Rate (product/ha) | Cowvine | sorghum |
| 1 | Untreated | — | 0 | 0 |
| 2 | DS 11142 | 133 mL | 90 a | 100- |
| | Wipeout 450 | 1200 mL | | |
| 3 | DS 11142 | 267 mL | 98 a | 100- |
| | Wipeout 450 | 1200 mL | | |
| 4 | Fightback | 200 mL | 96 a | 100- |
| | Wipeout 450 | 1200 mL | | |
| 5 | Fightback | 400 mL | 99 a | 100- |
| | Wipeout 450 | 1200 mL | | |
| 6 | Wipeout 450 | 1200 mL | 67 b | 100- |

Treatments separated by different letters are significantly different at the 5% level of probability using the Duncans New Multiple Range test.
1. All rates of DS 11142 and Fightback in combination with Wipeout 450 provided commercially acceptable control of cowvine.
2. DS 11142 provided statistically similar levels of control of cowvine compared to Fightback at all assessments.
3. Wipeout 450 alone did not provide acceptable control of cowvine.
4. All treatments provided complete control of volunteer sorghum.

### INDUSTRIAL APPLICABILITY

It will be appreciated from the data in the above tables that the efficacy of the formulations of the invention is at least comparable to that of prior art formulations. However, the formulations of the invention, being more concentrated, are more efficient.

1. A highly loaded emulsifiable concentrate (EC) co-formulation containing triclopyr and three or more amine salts of picloram.

2. The co-formulation of claim 1, wherein one of the amine salts of picloram is the alkylamine ethoxylate salt.

3. The co-formulation of claim 1 wherein there are three amine salts of picloram, wherein the three amine salts of picloram comprise the hexyloxypropylamine salt, the monoisopropylamine salt, and the alkylamine ethoxylate salt.

4. The co-formulation of claim 1, wherein the weight ratio of triclopyr to picloram is approximately 3:1 and the loading of triclopyr and picloram (as acid equivalent) is more than 400 g ai/L.

5. The co-formulation of claim 1, wherein the co-formulation contains triclopyr at a loading of about 450 g ae/L and/or picloram at a loading of about 150 g ae/L.

6. The co-formulation of claim 1, wherein said co-formulation further comprises 2-(2-ethoxyethoxy) ethanol as a solvent.

7. A method for preparing a highly loaded emulsifiable concentrate (EC) co-formulation containing triclopyr and at least three amine salts of picloram, the method including:
(a) mixing triclopyr in a solvent with picloram;
(b) adding a first emulsifier;
(c) adding a second emulsifier;
(d) adding a first amine reactant;
(e) adding a second amine reactant; and
(f) maintaining mixing until the formulation is clear and homogenous.

8. The method of claim 7, wherein the solvent is 2-(2-ethoxyethoxy) ethanol.

9. The method of claim 7, wherein the first emulsifier is TERMUL® 203 alcohol alkoxylate emulsifier.

10. The method of claim 7, wherein the second emulsifier is a tallow amine ethoxylate.

11. The method of claim 10, wherein the tallow amine ethoxylate is TERIC® 17M.

12. The method of claim 7, wherein the first amine reactant is hexyloxypropylamine.

13. The method of claim 7, wherein the second amine reactant is monoisopropylamine (MIPA).

14. A highly loaded emulsifiable concentrate (EC) co-formulation containing triclopyr and at least three amine salts of picloram, when made by the method of claim 7.

15. A method of controlling a weed, including providing a highly loaded emulsifiable concentrate (EC) co-formulation containing triclopyr and at least three amine salts of picloram according to claim 1, diluting the concentrate with water to provide an emulsion, and applying the diluted concentrate to the weed to be controlled.

16. The method of claim 15, wherein the diluted concentrate is applied as a foliar spray or as a boom spray.

17. The method of claim 15, wherein the diluted concentrate is applied with a surfactant or a penetrant.
